(19) United States
(12) Patent Application Publication
(10) Pub. No.: US 2013/0022785 A1
(43) Pub. Date: Jan. 24, 2013

(54) OLIGOSACCHARIDE/SILICON-CONTAINING BLOCK COPOLYMERS FOR LITHOGRAPHY APPLICATIONS

(71) Applicants: Christopher John Ellison, Austin, TX (US); Julia Cushen, Austin, TX (US); Issei Otsuka, Grenoble (FR); C. Grant Willson, Austin, TX (US); Christopher M. Bates, Austin, TX (US); Jeffery Alan Easley, Austin, TX (US); Redouane Borsali, Grenoble-Saint Martin d'Hares (FR); Sebastien Fort, Grenoble-Saint Martin d'Hares (FR); Sami Halila, Beaucroissant (FR)

(72) Inventors: Christopher John Ellison, Austin, TX (US); Julia Cushen, Austin, TX (US); Issei Otsuka, Grenoble (FR); C. Grant Willson, Austin, TX (US); Christopher M. Bates, Austin, TX (US); Jeffery Alan Easley, Austin, TX (US); Redouane Borsali, Grenoble-Saint Martin d'Hares (FR); Sebastien Fort, Grenoble-Saint Martin d'Hares (FR); Sami Halila, Beaucroissant (FR)

(73) Assignee: Board of Regents, The University of the Texas System

(21) Appl. No.: 13/528,314

(22) Filed: Jun. 20, 2012

Related U.S. Application Data
(60) Provisional application No. 61/499,354, filed on Jun. 21, 2011.

(51) Int. Cl. C08F 283/06; B44C 1/22; B32B 33/00; B05D 3/00; B05D 3/12; B82Y 30/00

(52) U.S. Cl. 428/141; 525/54.3; 427/331; 427/335; 427/240; 216/49; 977/700

(57) ABSTRACT

The present invention discloses diblock copolymer systems that self-assemble to produce very small structures. These co-polymers consist of one block that contains silicon and another block comprised of an oligosaccharide that are coupled by azide-alkyne cycloaddition.

### FIELD OF THE INVENTION

The present invention relates to a block-copolymer derived from two (or more) monomeric species, at least one of which incorporates a silicon atom and at least one of which incorporates an oligosaccharide. Such compounds have many uses including multiple applications in the semiconductor industry including patterning of templates for use in nanoimprint lithography and applications in biomedical applications.

### BACKGROUND OF THE INVENTION

The improvement in areal density in hard disk drives using conventional multigrain media is currently bound by the superparamagnetic limit [1]. Bit patterned media can circumvent this limitation by creating isolated magnetic islands separated by a nonmagnetic material. Nanoimprint lithography is an attractive solution for producing bit patterned media if a template can be created with sub-25 nm features [2]. Resolution limits in optical lithography and the prohibitive cost of electron beam lithography due to slow throughput [3] necessitate a new template patterning process. The self-assembly of diblock copolymers into well-defined structures [4] on the order of 5-100 nm produces features on the length scale required for production of bit patterned media. This is most efficiently accomplished by using the block copolymers to produce templates for imprint lithography [5]. With the availability of the proper template, imprint lithography can be employed to produce bit patterned media efficiently. Previous research has targeted block copolymers that produce hexagonally packed cylindrical morphology with selective silicon incorporation into one block for etch resistance [6] through post-polymerization SiO₂ growth [7], silica deposition using supercritical CO₂ [8], and silicon-containing ferrocenyl monomers [9]. What is needed is method to create an imprint template with sub-100 nm features that can be etched with the good oxygen etch contrast that silicon provides.

### SUMMARY OF THE INVENTION

The present invention contemplates silicon and oligosaccharide-containing compositions, methods of synthesis, and methods of use. More specifically, the present invention relates, in one embodiment, to a blockcopolymer derived from two (or more) monomeric species, at least one of which comprising silicon and at least one of which incorporates an oligosaccharide. Such compounds have many uses including multiple applications in the semiconductor industry including making templates for nanoimprint lithography and applications in biomedical applications.

In one embodiment, the present invention discloses diblock copolymer systems that self-assemble to produce very small structures. It is not intended that the present invention be limited to a specific silicon and oligosaccaraide-containing copolymer. These co-polymers are comprised of one block that contains silicon, for example, polytrimethylsilylstyrene, and another block comprised of an oligosaccharide, for example oligomaltoheptaose, that are covalently coupled by, for example azide-alkyne cycloaddition.

There are several advantages and special characteristics associated with embodiments of the present invention including: the smallest known block copolymer feature sizes attainable, a good oxygen etch contrast (oligosaccharide etches quickly while silicon-containing block etches slowly in oxygen etch), a simple synthesis process, both blocks have high glass transition temperatures (solid at room temperature), and good solvent selectivity between blocks of copolymer.

There are several applications for the various embodiments of the present invention. Oligosaccharide/silicon-containing block copolymers have potential applications for overcoming feature-size limitations in nanoscale lithographic patterning. The compatibility of block copolymer patterning with current semiconductor and magnetic information storage processing makes nanoscale lithography with block copolymers a potentially viable solution to this problem.

The need to overcome feature-size limitations in conventional lithography has led to the development of new patterning techniques using block copolymer templates. Ideal block copolymer systems for these applications have high etch contrast between blocks to promote good feature resolution and high chi-parameters to achieve small features. An additional desirable attribute is polymers with high silicon content such that they form a robust oxide mask during reactive ion etching with oxygen. To achieve etch contrast; these silicon-containing polymers can be incorporated into a block copolymer where the adjacent block is organic and etches easily. It is also observed that, in some cases, incorporating silicon into one of the blocks increases chi compared to similar silicon-deficient block copolymers. It is not intended that the present invention be limited to a specific silicon and oligosaccaraide-containing copolymer. Three such new block copolymer systems exhibiting morphologies that incorporate fast-etching oxygen-rich oligosaccharides coupled to a silicon-containing polymer are fully described herein. The silicon-containing block provides sufficient etch resistance to achieve robust patterns in addition to promoting high chi parameters which allows access to cylinder diameters between 2 and 5 nm.

In one embodiment, the present invention includes block copolymer systems that self-assemble into nanoscale patterns with high etch contrast. In one embodiment, the system is comprised of one polymer block that contains silicon, and another polymer block comprised of an oligosaccharide. In one embodiment, the silicon-containing block is synthesized to contain an azide end-functionality and the oligosaccharide block is designed to contain an alkyne functionality. In one embodiment, the two blocks are coupled by a well-known azide-alkyne cycloaddition reaction. In one embodiment, the purpose of these block copolymers is to form nanostructured materials that can be used as etch masks in lithographic patterning processes. In one embodiment, the invention contemplates a block co-polymer comprised of at least one block of an oligiosaccharide and at least one block of a silicon containing polymer or oligomer with at least 10 wt % silicon.

Block copolymers used in nanoscale lithographic patterning typically self-assemble to produce structures with characteristic sizes from 10-100 nm. In one embodiment, the present invention includes block copolymers in which one of the blocks is a propargyl-functionalized oligosaccharide, a chemically modified naturally-occurring material that enables production of very small structures. In one embodiment, the invention includes the oligosaccharide block together with a silicon containing synthetic block, the combination of which provides very high etch selectivity.

In one embodiment, the invention is a potential solution to overcoming the feature-size limitations of conventional lithography techniques involves using self-assembled block copolymers to pattern nanoscale features. Block copolymer lithography circumvents physical and cost limitations present in conventional lithography techniques. Polymers with high segregation strength can faun features much smaller than those achievable by photolithography and can do so using a less time-intensive process than electron beam lithography. The combination of an oligosaccharide with a silicon containing block provides a unique combination of extremely high segregation strength and etch selectivity.

The embodiments of the present invention has advantages over block copolymer systems currently used for lithographic patterning primarily because, to the best of the inventors' knowledge, they exhibit the smallest block copolymer features known. Small features correlate to higher feature density for information storage and semiconductor applications. The systems are ideal for nanolithographic patterning due to the high etch contrast between the blocks. When using an oxygen plasma etching process, the oligosaccharide block etches very quickly while the silicon-containing block etches slowly. Compared to polystyrene-block-polydimethylsiloxane, a block copolymer that does exhibit good etch contrast with a liquid polydimethylsiloxane block, both blocks of the new block copolymer described in this invention have high glass transition temperatures which enables them to be rigid, dimensionally stable solids at room temperature.

In one embodiment, the self-assembly of a block copolymer comprised of a biocompatible oligosaccharide coupled to a silicon containing polymer can be used in biomedical applications. In solution, the solubility difference between the blocks can promote formation of vesicles which could be used for drug-delivery. In the bulk, biocompatible films for antithrombotic coatings could be formed due to the immunogenicity of the oligosaccharide block. Other nanostructured materials such as nanoporous membranes could be manufactured using these etchable materials.

It is not intended that the present invention be limited to a specific silicon-containing monomer or copolymer. Illustrative monomers are shown in FIG. 19.

In one embodiment, the invention relates to a method of synthesizing a silicon and oligosaccharide-containing block copolymer, comprising: a) providing first and second monomers, said first monomer comprising a silicon atom and said second monomer being a oligosaccharide based monomer lacking silicon that can be polymerized; b) treating said second monomer under conditions such that reactive polymer of said second monomer is formed; and c) reacting said first monomer with said reactive polymer of said second monomer under conditions such that said silicon-containing block copolymer is synthesized (e.g. a diblock, triblock etc.). In one embodiment, said silicon-containing block is synthesized to contain an azide end-functionality and the oligosaccharide block is designed to contain an alkyne functionality. In one embodiment, the two blocks are coupled by the azide-alkyne cycloaddition reaction. In one embodiment, the block copolymers form nanostructured materials that can be used as etch masks in lithographic patterning processes. In one embodiment, the block co-polymer comprised of at least one block of an oligiosaccharide and at least one block of a silicon containing polymer or oligomer with at least 10 wt % silicon. In one embodiment, one of the blocks is a propargyl-functionalized oligosaccharide. In one embodiment, one of the blocks is polytrimethylsilylstyrene. In one embodiment, one of the blocks is end-functionalized with azide. In one embodiment, said first monomer is trimethyl-(2-methylene-but-3-enyl)silane. In one embodiment the method further comprises d) precipitating said silicon-containing block copolymer in methanol. In one embodiment, said first monomer is a silicon-containing methacrylate. In one embodiment, said first monomer is methacryloxymethyltrimethylsilane (MTMSMA). In one embodiment, said oligosaccaride-containing block copolymer is mal₇-block-P(TMSSty). In one embodiment, said oligosaccaride-containing block copolymer is mal₇-block-P(MTMSMA). In one embodiment, said oligosaccaride-containing block copolymer is bCyD-block-PTMSSty. In one embodiment, said oligosaccaride-containing block copolymer is XGO-block-PTMSSty. In one embodiment, said second monomer is an oligosaccharide. In one embodiment, said oligosaccharide is an oligomaltoheptaose. In one embodiment, said oligosaccharide is an ethynyl-maltoheptaose. In one embodiment, said oligosaccharide is an ethynyl-maltoheptaose xyloglucooligosaccharide. In one embodiment, said oligosaccharide is an ethynyl-xyloglucooligosaccharide. In one embodiment, oligosaccharide is an ethynyl-βCyD. In one embodiment, said oligosaccharide is mono-6^{A}-(p-tolylsulfonyl)-β-cyclodextrin. In one embodiment, said oligosaccharide is mono-6^{A}-N-propargylamino-6^{A}-deoxy-β-cyclodextrin. In one embodiment, the method further comprises the step d) coating a surface with said block copolymer so as to create a block copolymer film. In one embodiment, the method further comprises the step e) treating said film under conditions such that nanostructures form. In one embodiment, said nanostructures comprises cylindrical structures, said cylindrical structures being substantially vertically aligned with respect to the plane of the surface. In one embodiment, said nanostructures comprises spherical structures. In one embodiment, said treating comprises exposing said coated surface to a saturated atmosphere of acetone or THF. In one embodiment, said surface is on a silicon wafer. In one embodiment, said surface is not pre-treated with a cross-linked polymer prior to step d). In one embodiment, said surface is pre-treated with a cross-linked polymer prior to step d). In one embodiment, a third monomer is provided and said block copolymer is a triblock copolymer. In one embodiment the invention is the film made according to the process described above.

In one embodiment, the invention relates to a method of forming nanostructures on a surface, comprising: a) providing a silicon and oligosaccharide-containing block copolymer block copolymer and a surface; b) spin coating said block copolymer on said surface to create a coated surface; and c) treating said coated surface under conditions such that nanostructures are formed on said surface. In one embodiment, said nanostructures comprise spheres. In one embodiment, said nanostructures comprises cylindrical structures, said cylindrical structures being substantially vertically aligned with respect to the plane of the surface. In one embodiment, said treating comprises exposing said coated surface to a saturated atmosphere of acetone or THF. In one embodiment, said surface is on a silicon wafer. In the preferred embodiment, not demonstrated, the surface is a transparent material such as fused silica of the sort used to fabricate imprint lithography templates. In one embodiment, said surface is not pre-treated with a cross-linked polymer prior to step b). In one embodiment, said surface is pre-treated with a cross-linked polymer prior to step b). In one embodiment the invention is the film made according to the process described above. In one embodiment, the method further comprises the step e) etching said nanostructure-containing coated surface.

In one embodiment, the silicon and oligosaccharide-containing block copolymer is applied to a surface, for example, by spin coating, preferably under conditions such that physical features, such as nanostructures that are less than 100 nm in size (and preferably 50 nm or less in size), are formed on the surface. Thus, in one embodiment, the method further comprises the step d) coating a surface with said block copolymer so as to create a block copolymer film. In one embodiment, the method further comprises the step e) treating said film under conditions such that nanostructures form. In one embodiment, said nanostructures comprise cylindrical structures, said cylindrical structures being substantially vertically aligned with respect to the plane of the surface. In one embodiment, said nanostructures comprise spheres. In one embodiment, said treating comprises exposing said coated surface to a saturated atmosphere of a solvent (a process also known as “annealing”), such as acetone or THF. In one embodiment, said surface is on a silicon wafer. In another embodiment, said treating comprises exposing said coated surface to heat. In one embodiment, the film can have different thicknesses. In one embodiment, said surface is not pre-treated with a cross-linked polymer prior to step d). In one embodiment, said surface is pre-treated with a cross-linked polymer prior to step d). In one embodiment, a third monomer is provided and reacted, and the resulting block copolymer is a triblock copolymer. In one embodiment, the invention contemplates a film made according to the process above. In one embodiment, the method further comprises the step f) etching said nanostructure-containing coated surface.

In one embodiment, the invention relates to a method of foaming nano structures on a surface, comprising: a) providing a silicon and oligosaccharide-containing block copolymer (such as the Mal₇-block-P(MTMSMA) copolymer) and a surface; b) spin coating said copolymer on said surface to create a coated surface; and c) treating said coated surface under conditions such that nanostructures are formed on said surface. In one embodiment, said nanostructures comprise spheres. In one embodiment, said nanostructures comprise cylindrical structures, said cylindrical structures being substantially vertically aligned with respect to the plane of the surface. In one embodiment, said treating comprises exposing said coated surface to a saturated atmosphere of solvents such as acetone or THF (or other solvent that can dissolve at least one of the blocks in the copolymer and has a high vapor pressure at room temperature, including but not limited to toluene, benzene, etc.) In one embodiment, said surface is on a silicon wafer. In one embodiment, said surface is not pre-treated with a cross-linked polymer prior to step b). In one embodiment, said surface is pre-treated with a cross-linked polymer prior to step b). In one embodiment, nanostructures less than 100 nm in size (and preferably 50 nm or less) are made with the copolymer by annealing using heat or solvents (as described herein). In a preferred embodiment, such nanostructures are hexagonally packed cylindrical morphology with the domain spacing of approximately 50 nm or less. However the nanostructures are made, in one embodiment, the method further comprises etching said nanostructures. In one embodiment, the present invention contemplates compositions comprising thin films (e.g. spin-coated films) of silicon and oligosaccharide-containing block copolymer comprising such nanostructures, e.g. films deposited on a surface.

Polymerization of these monomers can be done using a variety of methods. For example, epoxide polymers can be made using the methods of Hillmyer and Bates, Macromolecules 29:6994 (1996) [10]. Polymers of trimethylsilyl styrene are described by Harada et al., J. Polymer Sci. 43:1214 (2005) [11] and Misichronis et al., Int. J. Polymer Analysis and Char. 13:136 (2008) [12]. Polymerization of the TBDMSO-Styrene monomer is described by Hirao, A., Makromolecular Chem. Rapid. Commun., 3: 941 (1982) [13]. For example, said block copolymers are constructed according to methods described by Borsali et al. Langmuir 27, 4098-4103 (2011) [14]. In another embodiment, said block copolymers are assembled according to the methods described by Giacomelli, et al. Langmuir 26, 15734-15744 (2010) [15].

Without limiting the above, particularly good example includes: a general procedure is as follows: TMSiS, 2-(bromomethyl)-2-methylbutanoic acid, copper bromide, Me₆TREN, and a solvent such as Toluene are added to a reaction vessel. The solution is degassed with argon and then tin (II) ethylhexanoate is added, such as with via syringe. The solution is heated, such as being submerged in an oil bath at 90° C., and allowed to polymerize (such as for three hours and twenty minutes at which point it reached approximately 40% conversion). The polymer is then precipitated in methanol and dried in vacuo. A synthesis scheme for this reaction is summarized in FIG. 1.

Without limiting the above, particularly good example includes the Synthesis of poly(trimethylsilyl styrene) (PTMSiS): poly(trimethylsilyl styrnene) PTMSiS end-functionalized with azide. A synthesis scheme is shown in FIG. 3. PTMSiS (6000 mg, 1.7 mmol), sodium azide (325 mg, 5.0 mmol), and 80 mL DMF are added to a reaction vessel, such as a round bottom flask. The reaction was stirred overnight at room temperature. The polymer is precipitated in methanol, dried, and reprecipitated three times to remove excess sodium azide salt.

Without limiting the above, particularly good example includes the synthesis of N-maltoheptaosyl-3-acetamido-1-propyne (propargyl-Mal₇): A suspension of maltoheptaose (10.0 g, 8.67 mmol) in neat propargylamine (11.9 mL, 174 mmol) is stirred vigorously at room temperature until complete conversion of the starting material (72 h). After complete disappearance of the starting material, the reacting mixture is dissolved in methanol (100 mL), and then precipitated in CH₂Cl₂ (300 mL). The solid is filtrated and washed with a mixture of MeOH and CH₂Cl₂ (MeOH:CH₂Cl₂=1:3, v/v, 300 mL). A solution of acetic anhydride in MeOH (acetic anhydride:MeOH=1:20, v/v, 1 L) is added to the solid, and stirred overnight at room temperature. After complete consummation of the starting material, the solvent of the mixture is evaporated, and the traces of acetic anhydride removed by co-evaporation with a mixture of toluene and methanol (1:1, v/v).

Without limiting the above, particularly good example includes the synthesis of N-(XGO)-3-acetamido-1-propyne (propargyl-XGO): A suspension of xyloglucooligosaccharide (XGOs: made up of a mixture of hepta-, octa-, and nona-saccharides in the ratio 0.15:0.35:0.50, respectively.) (20 g, 12.1 mmol) in propargylamine (20 mL, 240.3 mmol) and 30 mL of methanol is stirred vigorously at room temperature for 3 days. Upon complete conversion of the starting material, excess propargylamine is removed under reduced pressure, at a temperature below 40° C. and then co-evaporated using a mixture of toluene and methanol (9:1, v/v). The residual yellow solid is dissolved in methanol and then precipitated with dichloromethane. The solid is filtered and washed with a mixture of methanol and dichloromethane (1:4, v/v). The solid is selectively N-acetylated by adding a solution of acetic anhydride in methanol (1:20, v/v). The reaction mixture is stirred for 16 h at room temperature, then the solvent is removed by evaporation, and co-evaporation with a mixture of toluene and methanol (1:1, v/v) to remove traces of acetic anhydride. The residue is dissolved in water and lyophilized to afford N-(XGO)-3-acetamido-1-propyne as a pure white solid.

Without limiting the above, particularly good example includes the synthesis of mono-6^{A}-N-propargylamino-6^{A}-deoxy-β-cyclodextrin (propargyl-βCyD): To a NaOH solution (20.0 g of NaOH in water 800 mL) is added β-cyclodextrin (40.0 g) at 0-5° C. p-Tolylsulfonyl chloride (TsCl, 16.0 g) is added into the solution with vigorous stirring at 0-5° C. After 2 h another portion of TsCl (24.0 g) is added and the mixture was stirred for 3 more hours. The unreacted TsCl is then filtered out. The filtrate is cooled to 0° C. and 240 mL of 10% HCl is added. The mixture is kept in the refrigerator overnight to afford a white solid product. The white solid is recrystallized in water to afford product. 10.0 g of mono-6A-(p-tolylsulfonyl)-β-cyclodextrin is added into 20 mL of propargylamine (10.0 g). The mixture is stirring at 65° C. for 24 h under the N₂ atmosphere. Then, the mixture is poured into 100 mL of acetonitrile (ACN) to obtain a solid product. The solid is recrystallized in methanol to afford 7.7 g product (yield 85%).

Without limiting the above, particularly good example includes the synthesis of Mal₇-b-P(TMSiS): A typical method of “click” reaction is as follows (Method A): P(TMSiS)—N₃ (674 mg, 1.87×10⁻⁴ mol, 1 eq.) is weighed in a flask and dissolved in DMF (15 g). Propargyl-Mal₇ (300 mg, 2.43×10⁻⁴ mol, 1.3 eq.) and PMDETA (48.6 mg, 2.80×10⁻⁴ mol, 1.5 eq.) are weighed in another flask and dissolved in DMF in (15 g). Both solutions are degassed by bubbling of Ar for 15 min. CuBr (40.3 mg, 2.80×10⁻⁴ mol, 1.5 eq.) is weighed in the other flask under Ar atmosphere and sealed with a rubber septum. To the flask of CuBr is added the solutions of P(TMSiS)—N₃ and propargyl-Mal₇ using stainless cannula under Ar atmosphere and stirred at 40° C. for 72 h. The reaction mixture is passed through an alumina column to remove the copper complex. The eluent is concentrated and precipitated in MeOH to afford Mal₇-b-P(TMSiS) as a white solid (375 mg, 42%). The reaction scheme is summarized in FIG. 6. Since maltoheptaose is soluble in methanol, there should be no free maltoheptaose left in the polymer.

Without limiting the above, particularly good example includes the synthesis of XGO-b-P(TMSiS). Method A iss applied to P(TMSiS)—N₃ (611 mg, 1.70×10⁻⁴ mol, 1 eq.), propargyl-XGO (300 mg, 2.21×10⁻⁴ mol, 1.3 eq.), PMDETA (44.1 mg, 2.55×10⁻⁴ mol, 1.5 eq.), and CuBr (36.5 mg, 2.55×10⁻⁴ mol, 1.5 eq.) in DMF (30 g). The reaction scheme is summarized in FIG. 9.

Without limiting the above, particularly good example includes the synthesis of βCyD-b-P(TMSiS). Method A is applied to P(TMSiS)—N₃ (473 mg, 1.31×10⁻⁴ mol, 1 eq.), propargyl-βCyD (200 mg, 1.71×10⁻⁴ mol, 1.3 eq.), PMDETA (34.1 mg, 1.97×10⁻⁴ mol, 1.5 eq.), and CuBr (28.2 mg, 1.97×10⁻⁴ mol, 1.5 eq.) in DMF (30 g). The reaction scheme is summarized in FIG. 10.

Without limiting the above, particularly good example includes the synthesis of poly(methyltrimethylsilyl methacrylate) (PMTMSMA): PMTMSMA was synthesized exactly as PTMSiS, except at a reaction temperature of 70° C. and for only 6 hours to complete conversion. Azide addition was performed as with PTMSiS. The reaction scheme is summarized in FIG. 11.

Without limiting the above, particularly good example includes the synthesis of Mal₇-b-P(MTMSMA): Method A was applied to P(MTMSMA)-N₃ (200 mg, 6.24×10⁻⁵ mol, 1 eq.), propargyl-Mal₇ (100 mg, 8.12×10⁻⁵ mol, 1.3 eq.), PMDETA (16.2 mg, 9.36×10⁻⁵ mol, 1.5 eq.), and CuBr (13.4 mg, 9.36×10⁻⁵ mol, 1.5 eq.) in DMF (10 g). The product was purified by a precipitation in MeOH/H₂O (1:1=v/v) instead of MeOH. The reaction scheme is summarized in FIG. 12.

### BRIEF DESCRIPTION OF THE DRAWINGS

For a more complete understanding of the features and advantages of the present invention, reference is now made to the detailed description of the invention along with the accompanying figures.

FIG. 1 shows PTMSiS Synthesis.

FIG. 2 shows a PTMSiS GPC trace.

FIG. 3 shows a scheme for azide addition to PTMSiS.

FIG. 4 shows the infared spectrum for the azide addition to PTMSiS.

FIG. 5 shows the NMR spectrum for the azide addition to PTMSiS.

FIG. 6 shows a scheme for the synthesis of maltoheptaose-b-P(TMSiS).

FIG. 7 shows reaction success confirmation by IR spectra.

FIG. 8 shows reaction success confirmation from GPC traces in THF.

FIG. 9 shows a scheme for XGO-b-P(TMSSty) synthesis.

FIG. 10 shows a scheme for βCyD-b-P(TMSSty) synthesis.

FIG. 11 shows a scheme for P(MTMSMA) synthesis.

FIG. 12 shows a scheme for maltoheptaose-b-P(MTMSMA) synthesis.

FIG. 13 shows GPC traces (in THF) of P(MTMSMA)-N₃ (dotted line) and mal₇-b-P(MTMSMA) (solid line).

FIG. 14 shows IR spectra of (A) P(MTMSMA)-N₃, (B) Mal₇-b-P(MTMSMA).

FIG. 15 shows BCP morphology by SAXS.

FIG. 16 shows AFM images of maltoheptaose-b-PTMSiS for a 6.8 nm film thickness phase image.

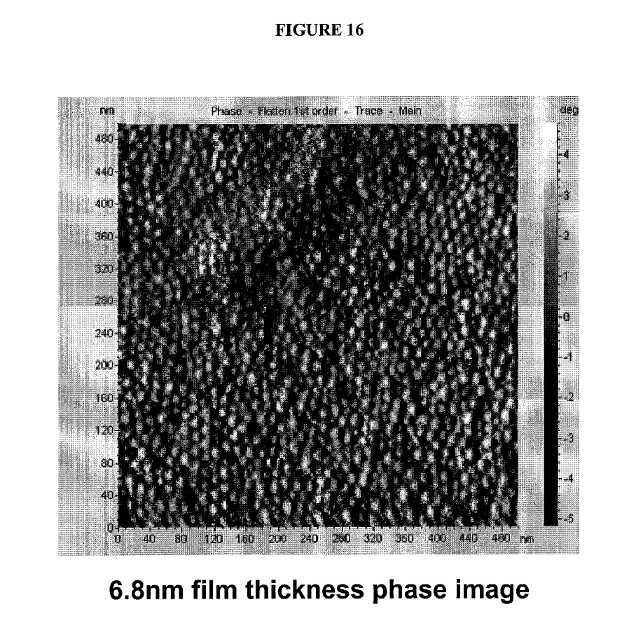

FIG. 17 shows AFM images of maltoheptaose-b-PTMSiS for a 38 nm film thickness phase image.

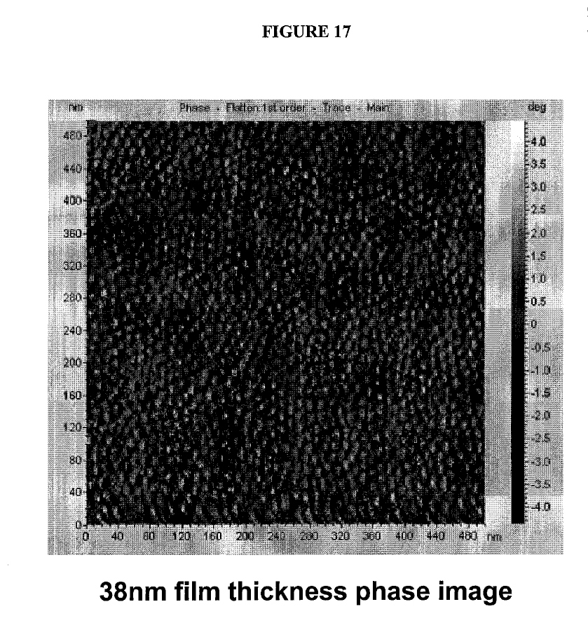

FIG. 18 shows AFM images of maltoheptaose-b-PTMSiS for a 124 nm film thickness phase image.

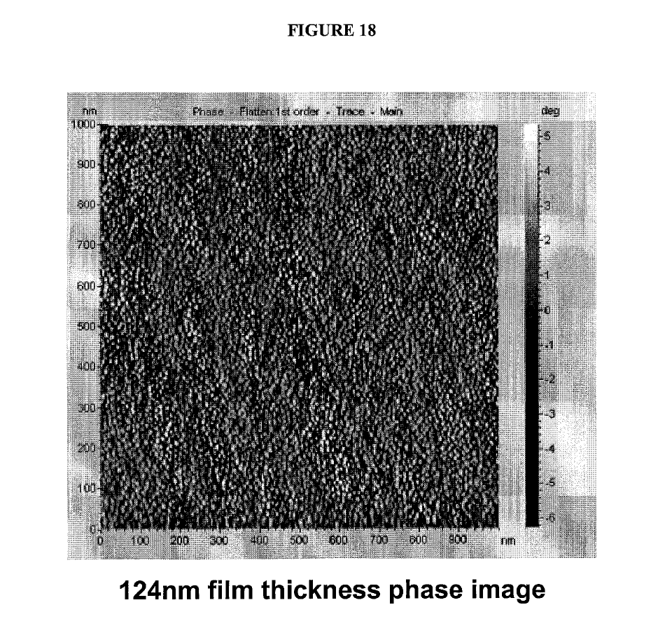

FIG. 19 shows non-limiting structures of illustrative silicon-containing monomers.

FIG. 20 shows the thermally induced cycloaddition and Cu(I) catalyzed cycloaddition reactions.

### DEFINITIONS

To facilitate the understanding of this invention, a number of terms are defined below. Terms defined herein have meanings as commonly understood by a person of ordinary skill in the areas relevant to the present invention. Terms such as “a”, “an” and “the” are not intended to refer to only a singular entity, but include the general class of which a specific example may be used for illustration. The terminology herein is used to describe specific embodiments of the invention, but their usage does not delimit the invention, except as outlined in the claims.

In addition, atoms making up the compounds of the present invention are intended to include all isotopic forms of such atoms. Isotopes, as used herein, include those atoms having the same atomic number but different mass numbers. By way of general example and without limitation, isotopes of hydrogen include tritium and deuterium, and isotopes of carbon include ¹³C and ¹⁴C. Similarly, it is contemplated that one or more carbon atom(s) of a compound of the present invention may be replaced by a silicon atom(s). Furthermore, it is contemplated that one or more oxygen atom(s) of a compound of the present invention may be replaced by a sulfur or selenium atom(s).

Trimethyl-(2-methylene-but-3-enyl)silane is represented by the following structure:

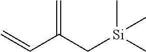

and abbreviated (TMSI) and whose polymeric version is

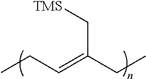

and is abbreviated P(TMSI).

Trimethyl(4-vinylphenyl)silane is another example of a styrene derivative and is represented by the following structure:

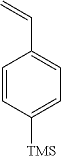

and abbreviated TMS-St and whose polymeric version is

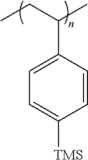

and is abbreviated P(TMS-St).

Tert-butyldimethyl(4-vinylphenoxy)silane is another example of a styrene derivative and is represented by the following structure:

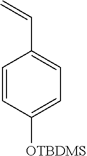 [SMILES: C=Cc1ccc(O[Si](C)(C)C(C)(C)C)cc1]

and abbreviated TBDMSO-St and whose polymeric version is

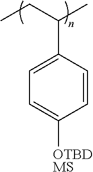

and is abbreviated P(TBDMSO-St).

Tert-butyldimethyl(oxiran-2-ylmethoxy)silane is an example of a silicon containing compound and is represented by the following structure:

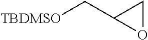 [SMILES: CC(C)(C)[Si](C)(C)OCC1CO1]

and is abbreviated TBDMSO-EO and whose polymeric version is

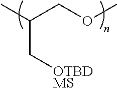

and is abbreviated P(TBDMSO-EO).

1,1-diphenylethene is represented by the following structure:

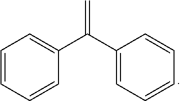

Methacryloxymethyltrimethylsilane is represented by the following structures:

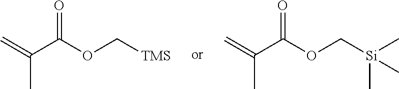

and abbreviated (MTMSMA) and whose polymeric version is

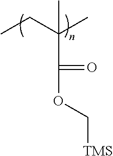

and is abbreviated P(MTMSMA).

Methyl 2-bromo-2-methylpropanoate is represented by the following structure:

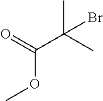

Ethylbromoisobutyrate or 2-(bromomethyl)-2-methylbutanoic acid is represented by the following structure:

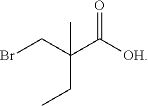

Tris(2-(dimethylamino)ethyl)amine is represented by the following structure:

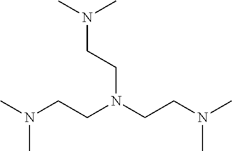

and abbreviated Me₆TREN.

Poly(trimethylsilyl styrnene) anion is represented by the following structure:

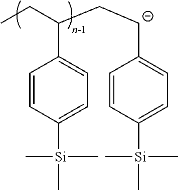

and abbreviated PTMSiS.

The poly(trimethylsilyl styrene) PTMSiS end-functionalized with azide is represented by the following structure:

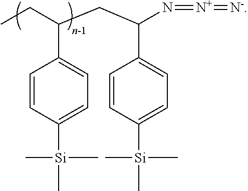

Ethynyl-Maltoheptaose is represented by the following structure:

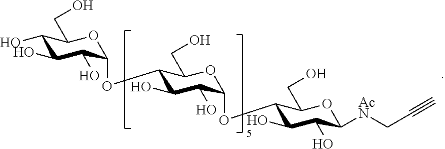

Poly(trimethylsilyl styrnene) azide, abbreviated P(TMSSty)-N₃, is represented by the following structure:

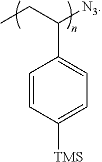

Maltoheptaose block poly(trimethylsilyl styrnene), abbreviated Mal₇-block-P(TMSSty), is represented by the following structure:

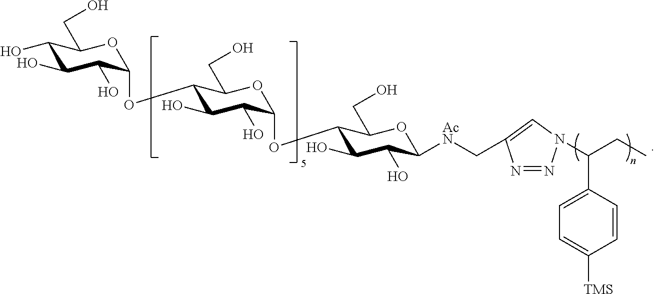

PMDTA or PMDETA, formally N,N,N′,N′,N″-pentamethyldiethylenetriamine, is an organic compound with the formula (Me₂NCH₂CH₂)₂NMe (Me is CH₃) and is represented by the following structure

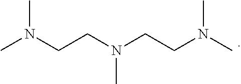

Ethynyl-xyloglucooligosaccharide (XGO) is represented by the following structure:

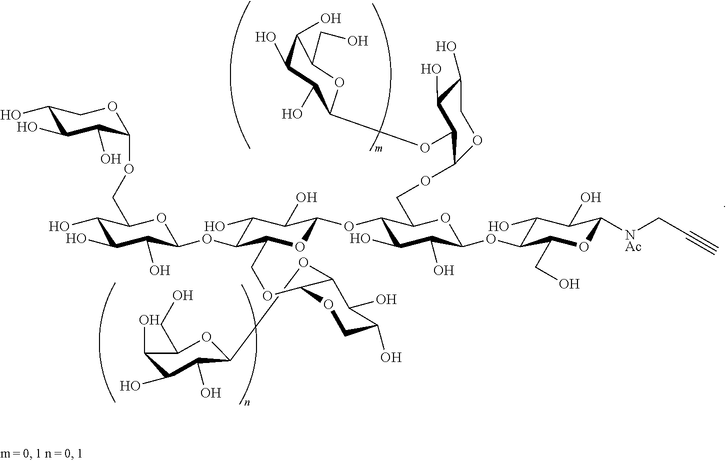

Xyloglucooligosaccharide block poly(trimethylsilyl styrnene), abbreviated XGO-block-PTMSSty, is represented by the following structure:

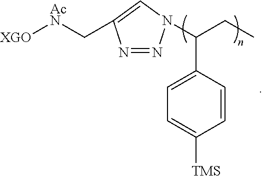

Ethynyl-βCyD is represented by the following structure:

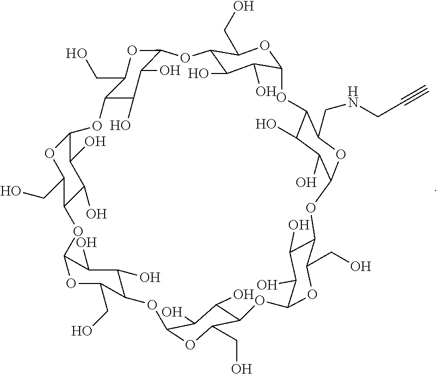 [SMILES: C#CCNCC1OC2OC3C(CO)OC(OC4C(CO)OC(OC5C(CO)OC(OC6C(CO)OC(OC7C(CO)OC(OC8C(CO)OC(OC1C(O)C2O)C(O)C8O)C(O)C7O)C(O)C6O)C(O)C5O)C(O)C4O)C(O)C3O]

6A-deoxy-β-cyclodextrin block poly(trimethylsilyl styrnene), abbreviated bCyD-block-PTMS Sty, is represented by the following structure:

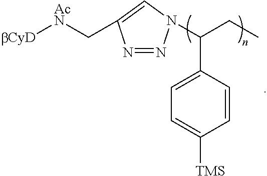

Poly(methacryloxymethyltrimethylsilane) azide, abbreviated P(MTMSMA)-N₃, is represented by the following structure:

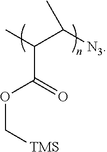

Maltoheptaose block poly(methacryloxymethyltrimethylsilane), abbreviated Mal₇-block-P(MTMSMA), is represented by the following structure:

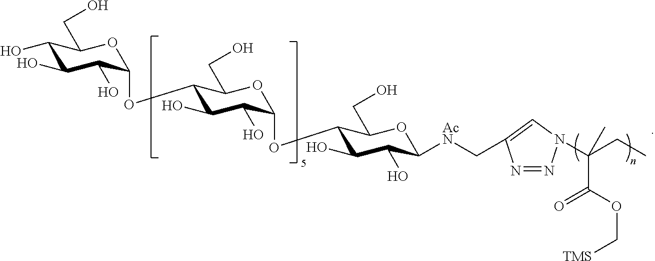

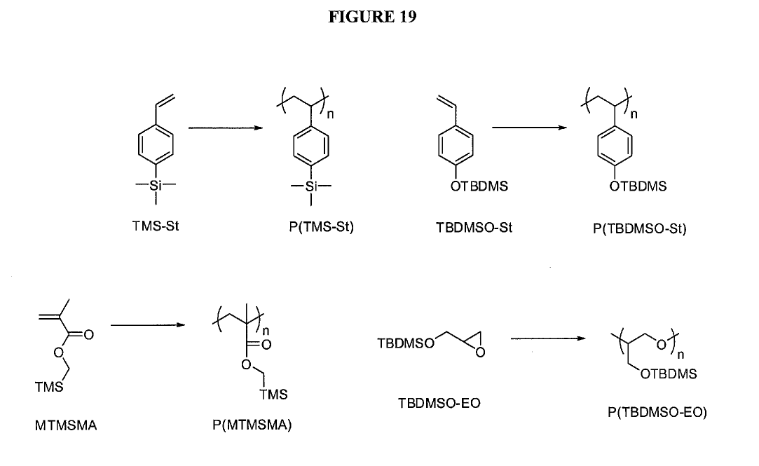

The present invention also contemplates styrene “derivatives” where the basic styrene structure is modified, e.g. by adding substituents to the ring. Derivatives of any of the compounds shown in FIG. 19 can also be used. Derivatives can be, for example, hydroxy-derivatives or halo-derivatives. As used herein, “hydrogen” means —H; “hydroxy” means —OH; “oxo” means ═O; “halo” means independently —F, —Cl, —Br or —I.

### Azide-Alkyne Huisgen Cycloaddition Example

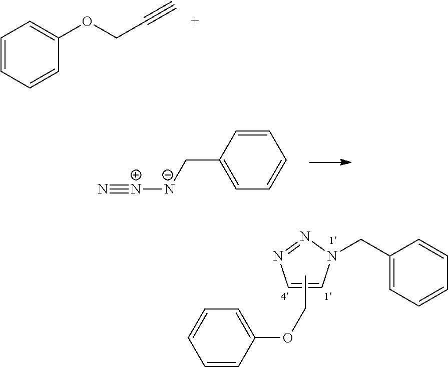

The Azide-Alkyne Huisgen Cycloaddition is a 1,3-dipolar cycloaddition between an azide and a terminal or internal alkyne to give a 1,2,3-triazole. For example, in the reaction above azide 2 reacts neatly with alkyne 1 to afford the triazole 3 as a mixture of 1,4-adduct and 1,5-adduct at 98° C. in 18 hours.

For scientific calculations, room temperature (rt) is taken to be 21 to 25 degrees Celsius, or 293 to 298 kelvins (K), or 65 to 72 degrees Fahrenheit.

It is desired that the silicon-containing copolymer be used to create “nanostructures” on a surface, or “physical features” with controlled orientation. These physical features have shapes and thicknesses. For example, various structures can be formed by components of a block copolymer, such as vertical lamellae, in-plane cylinders, and vertical cylinders, and may depend on film thickness, surface treatment, and the chemical properties of the blocks. In a preferred embodiment, said cylindrical structures being substantially vertically aligned with respect to the plane of the first film. Orientation of structures in regions or domains at the nanometer level (i.e. “microdomains” or “nanodomains”) may be controlled to be approximately uniform, and the spatial arrangement of these structures may also be controlled. For example, in one embodiment, domain spacing of the nanostructures is approximately 50 nm or less. In another preferred embodiment, said nanostructures are spheres or spherical in shape. The methods described herein can generate structures with the desired size, shape, orientation, and periodicity. Thereafter, in one embodiment, these structures may be etched or otherwise further treated.

### DETAILED DESCRIPTION OF THE INVENTION

Due to the need for nanofeatures that can be etched, silicon-containing monomers were pursued. It is not intended that the present invention be limited by the nature of the silicon-containing monomer or that the present invention be limited to specific block polymers. However, to illustrate the invention, examples of various silicon-containing monomers and copolymers are provided.

### COPPER(I)-CATALYZED AZIDE-ALKYNE CYCLOADDITION

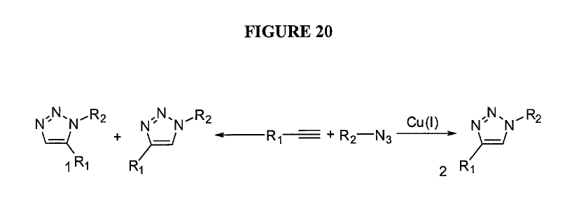

As a result of its mild conditions and high efficiency, the copper-catalyzed reaction of azide-alkyne cycloaddition (CuAAC) has become the most widely used click reaction in many areas of science [16-18]. Of all the reactions that could be qualified as click reactions, the CuAAC reaction is undoubtedly the premier example. Conducting a CuAAC reaction requires no protecting groups, no purification is generally required, and almost complete conversion and selectivity for the 1,4-disubstituted 1,2,3-triazole is achieved, unlike the mixture of products from the thermally induced cycloaddition reactions (FIG. 20) [19].

### GENERAL MATERIALS AND METHODS

Reagents. All reagents were purchased from Sigma-Aldrich Chemical Co. and used without further purification unless otherwise stated. AP410 and AP310 were purchased from AZ Clariant. THF was purchased from JT Baker. Chloroprene 50 wt % in xylenes was purchased from Pfaltz & Bauer. Cyclohexane was purified with a Pure Solv MD-2 solvent purification system.

Purifications. All purifications and polymerizations were performed under an Ar atmosphere using standard Schlenk techniques. [20] TMSI was vacuum distilled twice from n-butyllithium. Cyclohexane was purified with a Pure Solv MD-2 solvent purification system. The cyclohexane was run through A-2 alumina to remove trace amounts of water followed by a supported Q-5 copper redox catalyst to remove oxygen [21].

Instrumentation. All ¹H and ¹³C NMR spectra were recorded on a Varian Unity Plus 400 MHz instrument. All chemical shifts are reported in ppm downfield from TMS using the residual protonated solvent as an internal standard (CDCl₃, ¹H 7.26 ppm and ¹³C 77.0 ppm). Molecular weight and polydispersity data were measured using an Agilent 1100 Series Isopump and Autosampler and a Viscotek Model 302 TETRA Detector Platform with 3 Iseries Mixed Bed High MW columns against polystyrene standards. HRMS (CI) was obtained on a VG analytical ZAB2-E instrument. IR data were recorded on a Nicolet Avatar 360 FT-IR and all peaks are reported in cm⁻¹. Glass transition temperatures (T_{g}) were recorded on a TA Q100 Differential Scanning Calorimeter (DSC).

### Example 1

### Synthesis of poly(trimethylsilyl styrene) (PTMSiS)

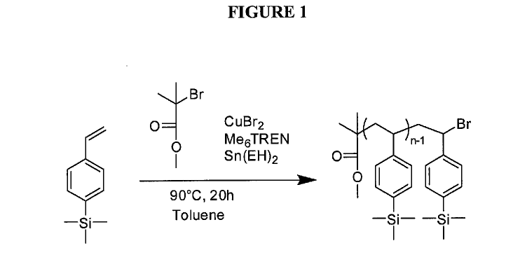

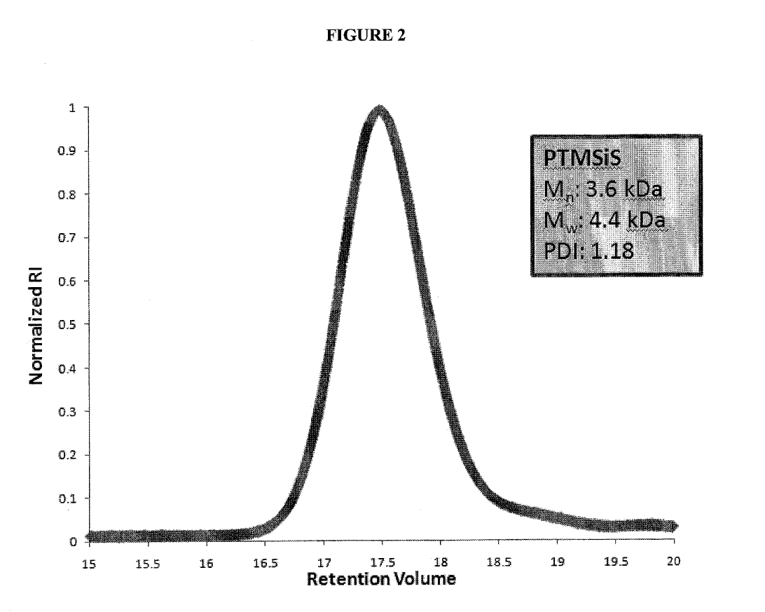

Trimethylsilyl styrene (TMSiS) was synthesized following a previously reported procedure [11] and was polymerized by Activators Regenerated by Electron Transfer Atom Transfer Radical Polymerization (ARGET ATRP). The general procedure is as follows: TMSiS (23.05 g, 130.7 mmol), ethylbromoisobutyrate (2-(bromomethyl)-2-methylbutanoic acid) (554 mg, 2.8 mmol), copper bromide (6.3 mg, 0.028 mmol), Me₆TREN (65 mg, 0.284 mmol), and Toluene (27.5 mL) were added to a round bottom flask. The solution was degassed with argon for 10 min and then tin (II) ethylhexanoate (115 mg, 0.284 mmol) was added via syringe. The solution was submerged in an oil bath at 90° C. and allowed to polymerize for three hours and twenty minutes at which point it reached approximately 40% conversion. The polymer was precipitated in methanol and dried in vacuo. The synthesis scheme for this reaction is summarized in FIG. 1. Molecular weight was analyzed by gel permeation chromatography (FIG. 2).

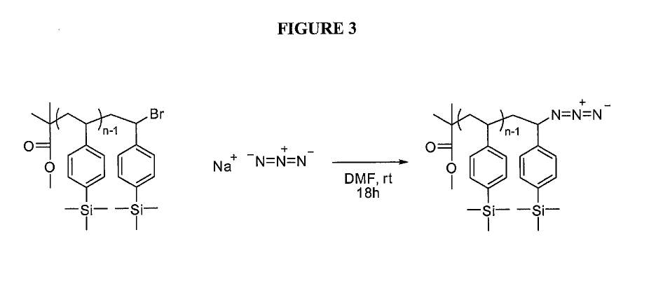

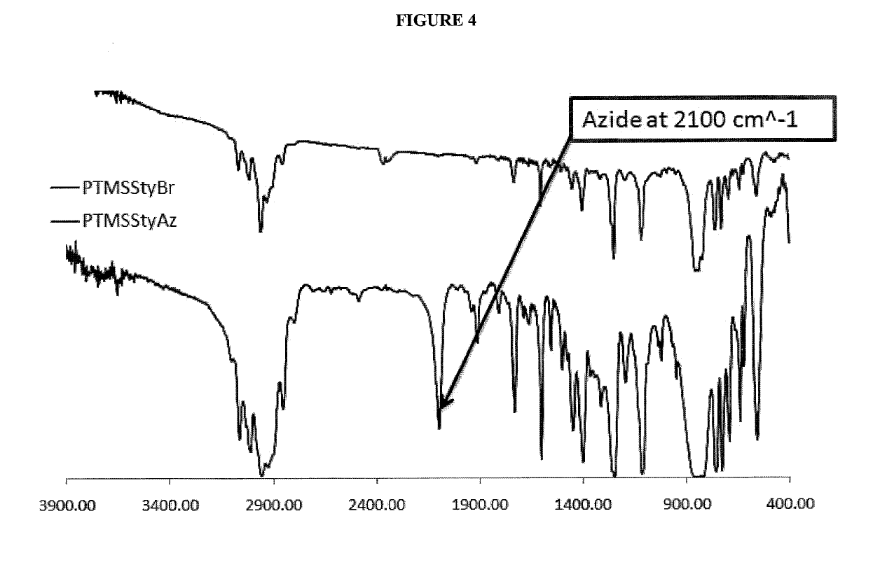

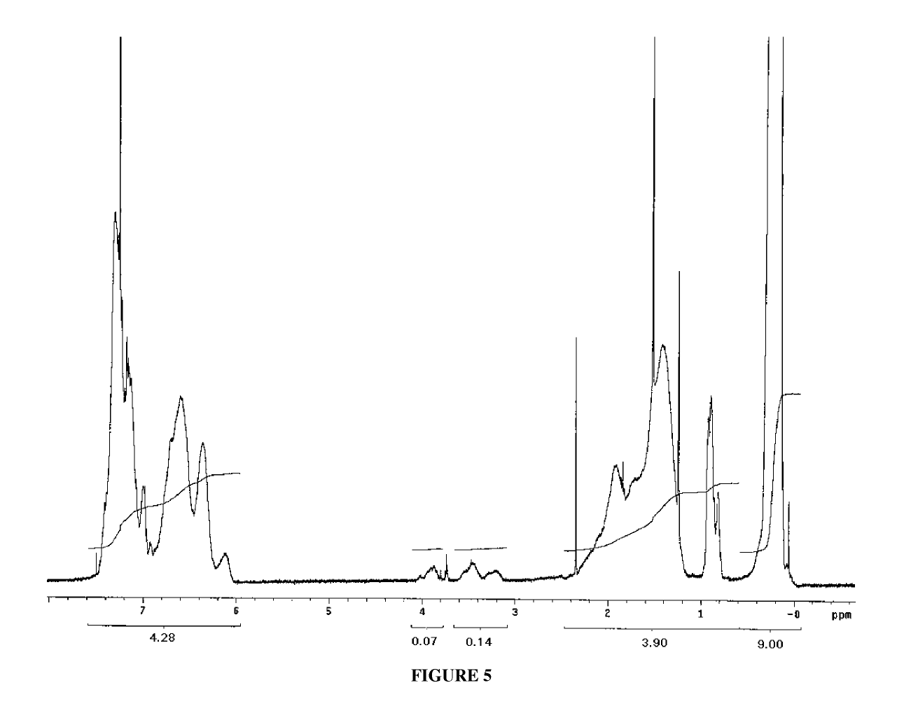

The poly(trimethylsilyl styrnene) PTMSiS was then end-functionalized with azide. The synthesis scheme is shown in FIG. 3. PTMSiS (6000 mg, 1.7 mmol), sodium azide (325 mg, 5.0 mmol), and 80 mL DMF were added to a round bottom flask. The reaction was stirred overnight at room temperature. The polymer was precipitated in methanol, dried, and reprecipitated three times to remove excess sodium azide salt. Presence of the azide end group was confirmed by infrared spectroscopy (FIG. 4), where it is apparent that an azide peak appears at 2100 cm⁻¹ after azide addition. NMR end group analysis also confirms close to 100% end functionalization, as it is apparent that the terminal hydrogen completely shifts on the NMR spectrum after azide functionalization (FIG. 5).

### Example 2

### Synthesis of N-maltoheptaosyl-3-acetamido-1-propyne (propargyl-Mal₇)

A suspension of maltoheptaose (10.0 g, 8.67 mmol) in neat propargylamine (11.9 mL, 174 mmol) was stirred vigorously at room temperature until complete conversion of the starting material (72 h), checked by TLC (eluent: BuOH/EtOH/H₂O=1/3/1). After complete disappearance of the starting material, the reacting mixture was dissolved in methanol (100 mL), and then precipitated in CH₂Cl₂ (300 mL). The solid was filtrated and washed with a mixture of MeOH and CH₂Cl₂ (MeOH:CH₂Cl₂=1:3, v/v, 300 mL). A solution of acetic anhydride in MeOH (acetic anhydride:MeOH=1:20, v/v, 1 L) was added to the solid, and stirred overnight at room temperature. After complete disappearance of the starting material checked by TLC (eluent: CH₃CN/H₂O=13/7), the solvent of the mixture was evaporated, and the traces of acetic anhydride were removed by co-evaporation with a mixture of toluene and methanol (1:1, v/v). The resulting solid was dissolved in water and lyophilized to afford 1 as a white solid (8.75 g, 78%). R_{f}=0.34 (13:7, CH₃CN—H₂O). ¹H NMR (D₂O): δ 5.46 and 5.00 (2×d, 1H, rotamers, J₁₋₂=9.20 Hz and J₁₋₂=8.87 Hz, H-1^{GlcI}), 5.36-5.31 (m, 6H, H-1^{GlcII-GlcVII)}, 4.24-3.30 (m, 44H, H-2, 3, 4, 5, 6a, 6b^{GlcI-GlcVII}, and NCH₂), 2.66 and 2.50 (2×s, 1H, rotamers, C≡CH), 2.24 and 2.16 (2×s, 3H, rotamers, NCOCH₃). ¹³C NMR (D₂O): δ 176.22, 175.04, 100.09-99.76, 86.80, 82.03, 80.26, 79.64, 77.47, 77.20-76.85, 76.38, 76.23, 73.68, 73.23, 73.08, 72.10, 72.06, 71.90, 71.85, 71.54, 70.58, 70.08, 69.69, 60.84, 60.78, 33.19, 30.44, 21.98, 21.51. HRMS ESI-TOF (m/z)

Calcd for [M+Na]⁺: 1254.4123. Found: 1254.4122.

### Example 3

### Synthesis of N-(XGO)-3-acetamido-1-propyne(propargyl-XGO)

A suspension of xyloglucooligosaccharide (XGOs: made up of a mixture of hepta-, octa-, and nona-saccharides in the ratio 0.15:0.35:0.50, respectively.) (20 g, 12.1 mmol) in propargylamine (20 mL, 240.3 mmol) and 30 mL of methanol was stirred vigorously at room temperature for 3 days. Upon complete conversion of the starting material, checked by t.l.c., excess propargylamine was removed under reduced pressure, at a temperature below 40° C. and then co-evaporated using a mixture of toluene and methanol (9:1, v/v). The residual yellow solid was dissolved in methanol and then precipitated with dichloromethane. The solid was filtered and washed with a mixture of methanol and dichloromethane (1:4, v/v). The solid was selectively N-acetylated by adding a solution of acetic anhydride in methanol (1:20, v/v). The reaction mixture was stirred for 16 h at room temperature, then the solvent was removed by evaporation, and co-evaporation with a mixture of toluene and methanol (1:1, v/v) to remove traces of acetic anhydride. The residue was dissolved in water and lyophilized to afford 4 as a pure white solid (20 g, 94%). Rf=0.27 (nona-), 0.34 (octa-), 0.4 (hepta-saccharides) (7:3 CH3CN—H2O). 1H NMR (400 MHz, D₂O): dppm 5.44 (d, J1-2=8.61 Hz, H-1GlcI), 5.18, 5.02 (d, H-1Xyl), 4.90-4.60 (m, H-1Glc and Gal), 4.50-3.20 (m, H-2,3,4,5,6Glc, Gal and Xyl and NCH2), 2.68 and 2.51 (2×s, rotamers, C_CH), 2.22 and 2.15 (2×s, rotamers, CH3 (Ac.)). MS MALDI-TOF: m/z [M+Na]+ 1163.87 (hepta-), [M+Na]+ 1325.87 (octa-), [M+Na]+1487.84 (nona-saccharides). IR (KBr): n 3600-3100 (O—H, sugars and C—H, alkyne), 3100-2700 (C—H, sugars), 1645 cm⁻¹ (C═O, amide).

### Example 4

### Synthesis of Mono-6^{A}-N-propargylamino-6^{A}-deoxy-β-cyclodextrin(propargyl-βCyD)

(i) Mono-6^{A}-(p-tolylsulfonyl)-β-cyclodextrin: To a NaOH solution (20.0 g of NaOH in water 800 mL) was added 13-CD (40.0 g) at 0-5° C. p-Tolylsulfonyl chloride (TsCl, 16.0 g) was added into the solution with vigorous stirring at 0-5° C. After 2 h another portion of TsCl (24.0 g) was added and the mixture was stirred for 3 more hours. The unreacted TsCl was then filtered out.

The filtrate was cooled to 0° C. and 240 mL of 10% HCl was added. The mixture was kept in the refrigerator overnight to afford a white solid product. The white solid was recrystallized in water to afford 11.8 g of product (yield 26%). ¹³C NMR (100 MHz, [²H₆]dimethyl sulfoxide (DMSO-d₆)) δ: 21.6, 59.5, 59.8, 60.1, 69.3, 70.0, 72.0, 72.3, 72.5, 72.6, 72.9, 73.3, 80.9, 81.4, 81.7, 81.8, 101.5, 102.2, 102.5, 127.9, 130.3, 132.9, 145.3. Positive ion ultra-performance liquid chromatography (UPLC)-quadrupole/time of flight (Q/TOF)-MS m/z 1289.3824 for [M+H]+, calcd (C₄₉H₇₇O₃₇S) 1289.3864.

(ii) Mono-6A-N-propargylamino-6A-deoxy-β-cyclodextrin: 10.0 g of mono-6A-(p-tolylsulfonyl)-β-cyclodextrin was added into 20 mL of propargylamine (10.0 g). The mixture was stirring at 65° C. for 24 h under the N₂ atmosphere. Then, the mixture was poured into 100 mL of acetonitrile (ACN) to obtain a solid product. The solid was recrystallized in methanol to afford 7.7 g product (yield 85%). ¹³C NMR (100 MHz, DMSO-d6) δ: 37.8, 48.3, 60.1, 70.9, 72.4, 72.5, 73.2, 73.9, 81.7, 83.4, 102.0, 102.2, 102.5. Positive ion UPLC-Q/TOF-MS m/z 1172.4102 for [M+H]+, calcd (C₄₅H74O₃₄N) 1172.4092.

### Example 5

### Synthesis of Mal₇-b-P(TMSiS)

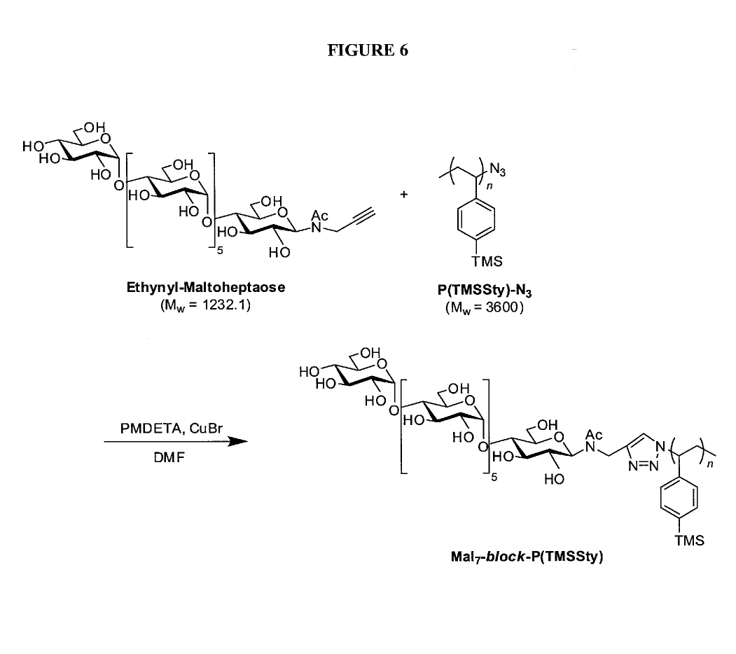

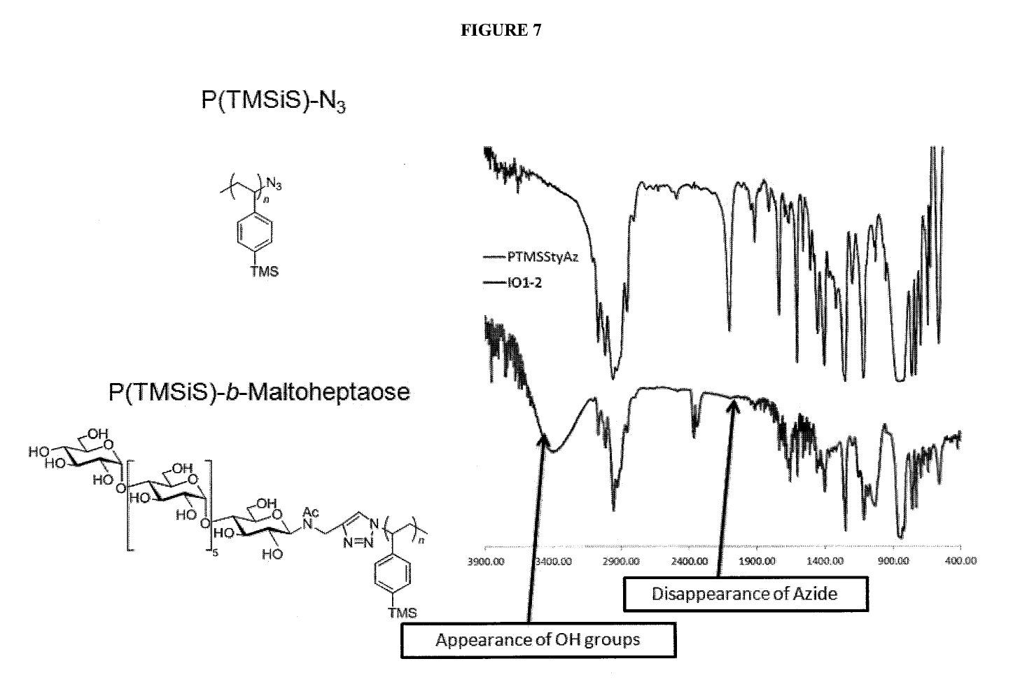

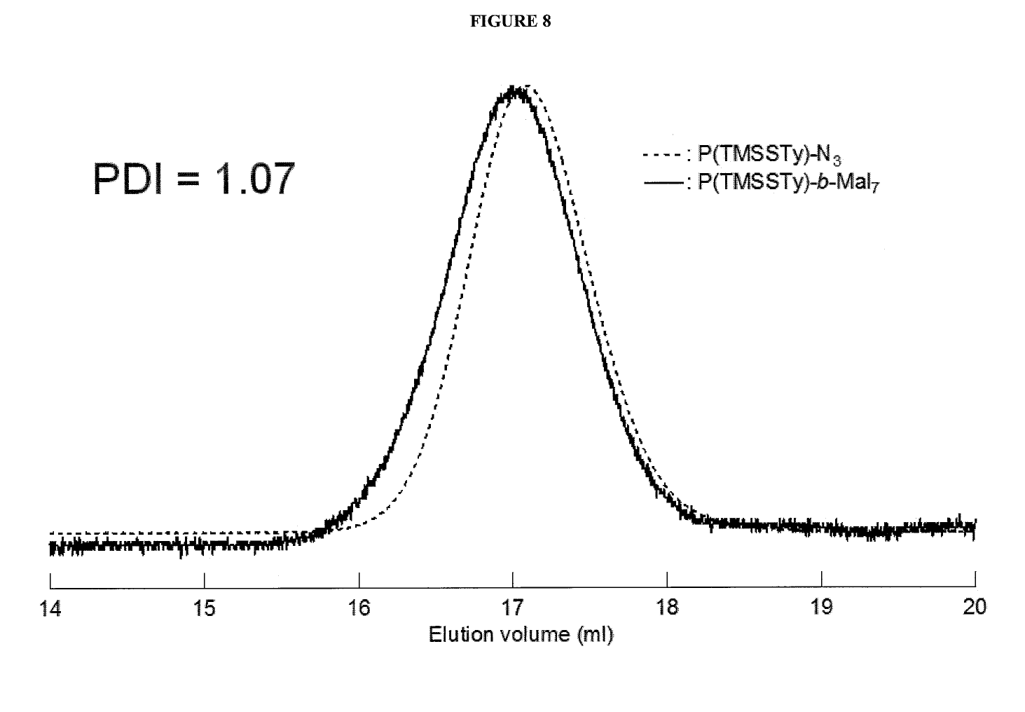

A typical method of “click” reaction is as follows (Method A): P(TMSiS)—N₃ (674 mg, 1.87×10⁻⁴ mol, 1 eq.) was weighed in a flask and dissolved in DMF (15 g). Propargyl-Mal₇ (300 mg, 2.43×10⁻⁴ mol, 1.3 eq.) and PMDETA (48.6 mg, 2.80×10⁻⁴ mol, 1.5 eq.) were weighed in another flask and dissolved in DMF in (15 g). Both solutions were degassed by bubbling of Ar for 15 min. CuBr (40.3 mg, 2.80×10⁻⁴ mol, 1.5 eq.) was weighed in the other flask under Ar atmosphere and sealed with a rubber septum. To the flask of CuBr were added the solutions of P(TMSiS)—N₃ and propargyl-Mal₇ using stainless cannula under Ar atmosphere and stirred at 40° C. for 72 h. The reaction mixture was passed through an alumina column to remove the copper complex. The eluent was concentrated and precipitated in MeOH to afford Mal₇-b-P(TMSiS) as a white solid (375 mg, 42%). The reaction scheme is summarized in FIG. 6. The completeness of the reaction was confirmed by IR and GPC. As shown in FIG. 7, the IR trace after the reaction shows a complete disappearance of the azide peak (all azide end functionality on the PTMSiS-N₃ disappears when it couples to the maltoheptoase) and a broad peak appears around 3400 cm⁻¹, indicating the presence of OH groups in the maltoheptaose. Since maltoheptaose is soluble in methanol, there should be no free maltoheptaose left in the polymer. The success of the reaction was also confirmed by a peak shift to a higher molecular weight as seen in the GPC (FIG. 8).

### Example 6

### Synthesis of XGO-b-P(TMSiS)

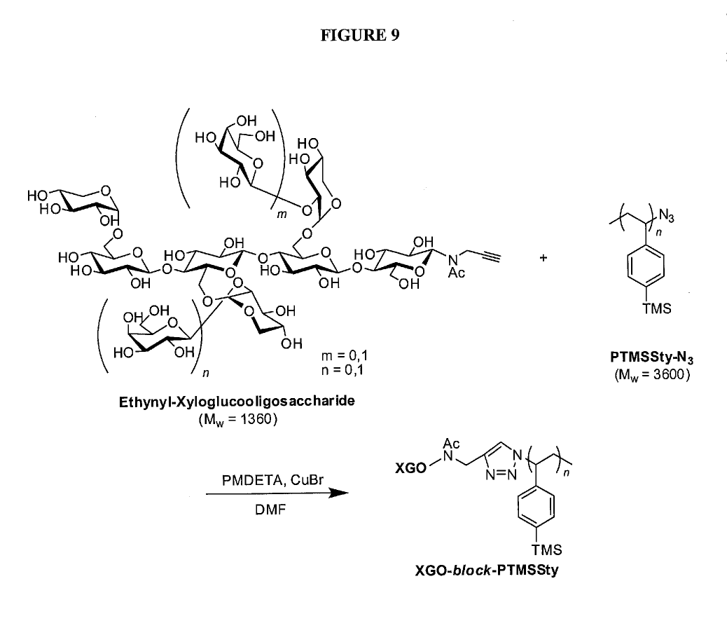

Method A was applied to P(TMSiS)—N₃ (611 mg, 1.70×10⁻⁴ mol, 1 eq.), propargyl-XGO (300 mg, 2.21×10⁻⁴ mol, 1.3 eq.), PMDETA (44.1 mg, 2.55×10⁻⁴ mol, 1.5 eq.), and CuBr (36.5 mg, 2.55×10⁻⁴ mol, 1.5 eq.) in DMF (30 g). The reaction scheme is summarized in FIG. 9. The polymer was characterized by IR and GPC with similar results as what was shown in FIG. 7 and FIG. 8.

### Example 7

### Synthesis of βCyD-b-P(TMSiS)

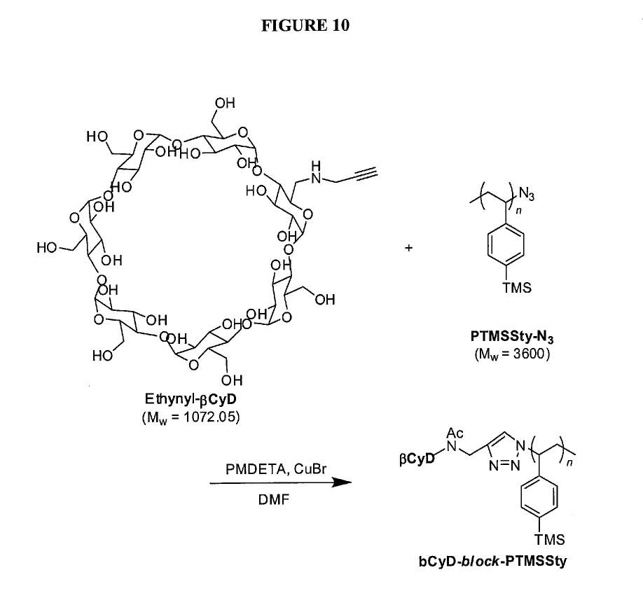

Method A was applied to P(TMSiS)—N₃ (473 mg, 1.31×10⁻⁴ mol, 1 eq.), propargyl-βCyD (200 mg, 1.71×10⁻⁴ mol, 1.3 eq.), PMDETA (34.1 mg, 1.97×10⁻⁴ mol, 1.5 eq.), and CuBr (28.2 mg, 1.97×10⁻⁴ mol, 1.5 eq.) in DMF (30 g). The reaction scheme is summarized in FIG. 10. The polymer was characterized by IR and GPC with similar results as what was shown in FIG. 7 and FIG. 8.

### Example 8

### Synthesis of poly(methyltrimethylsilyl methacrylate) (PMTMSMA)

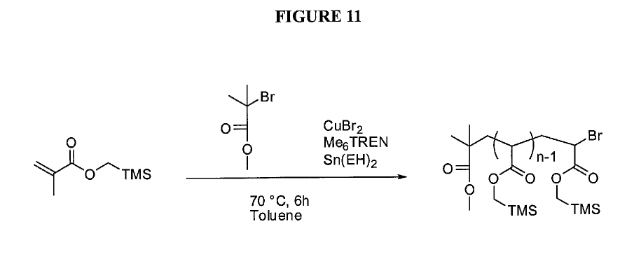

PMTMSMA was synthesized exactly as PTMSiS, except at a reaction temperature of 70° C. and for only 6 hours to complete conversion. Azide addition was performed as with PTMSiS and with similar characterization results as shown in FIG. 2, FIG. 3, FIG. 4, and FIG. 5. The reaction scheme is summarized in FIG. 11.

### Example 9

### Synthesis of Mal₇-b-P(MTMSMA)

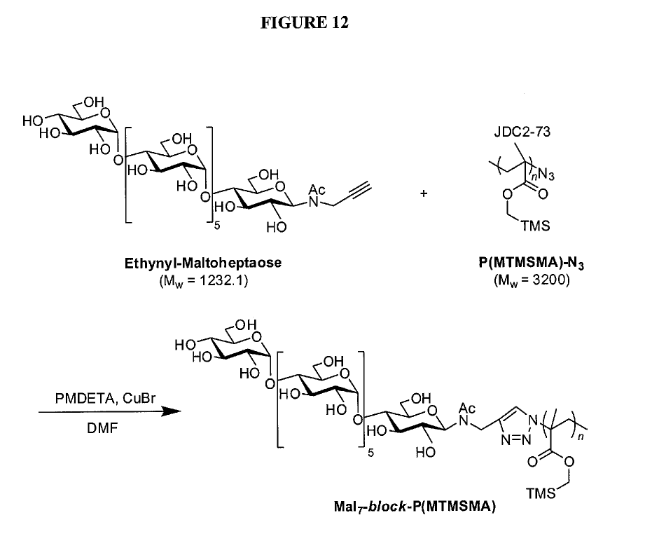

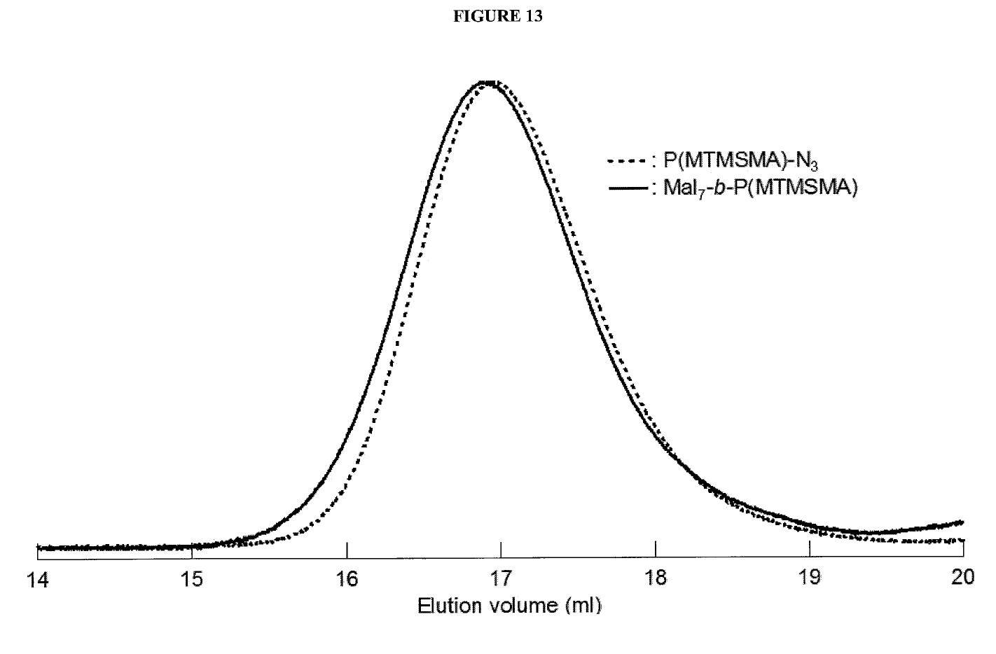

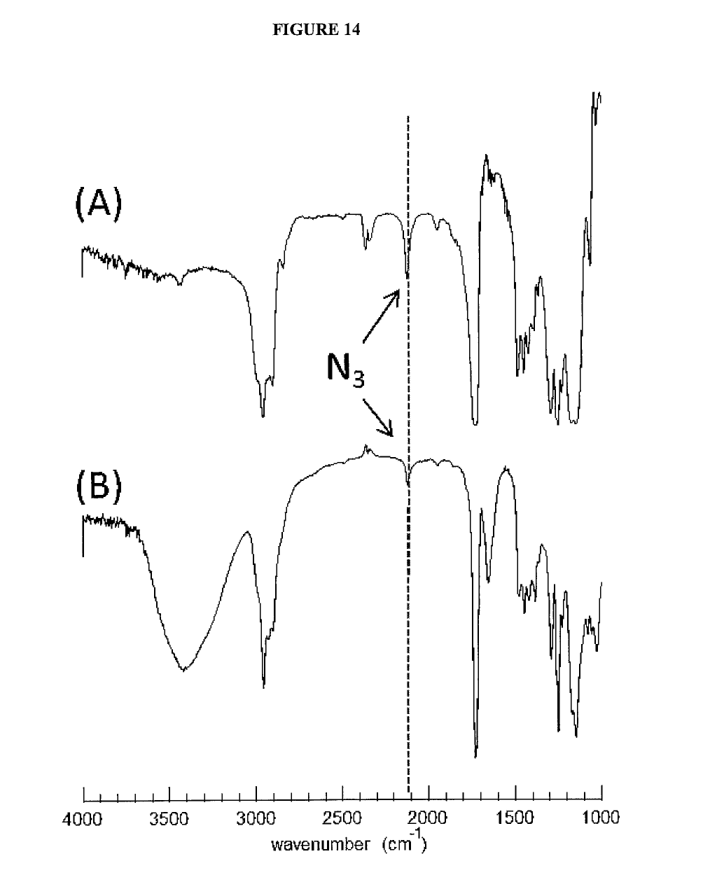

Method A was applied to P(MTMSMA)-N₃ (200 mg, 6.24×10⁻⁵ mol, 1 eq.), propargyl-Mal₇ (100 mg, 8.12×10⁻⁵ mol, 1.3 eq.), PMDETA (16.2 mg, 9.36×10⁻⁵ mol, 1.5 eq.), and CuBr (13.4 mg, 9.36×10⁻⁵ mol, 1.5 eq.) in DMF (10 g). The product was purified by a precipitation in MeOH/H₂O (1:1=v/v) instead of MeOH. The reaction scheme is summarized in FIG. 12. The polymer was characterized by IR and GPC with similar results as what was shown in FIG. 7 and FIG. 8, however it appears that complete reaction conversion was not achieved. FIG. 13 indicates a peak shift in the GPC trace, indicating that a higher molecular weight polymer was formed. However, FIG. 14 still shows a noticeable azide peak in the IR spectra, although it is reduced from the MTMSMAAz trace. The coupled polymer could be separated from the free polymer by fractional precipitation or column chromatography.

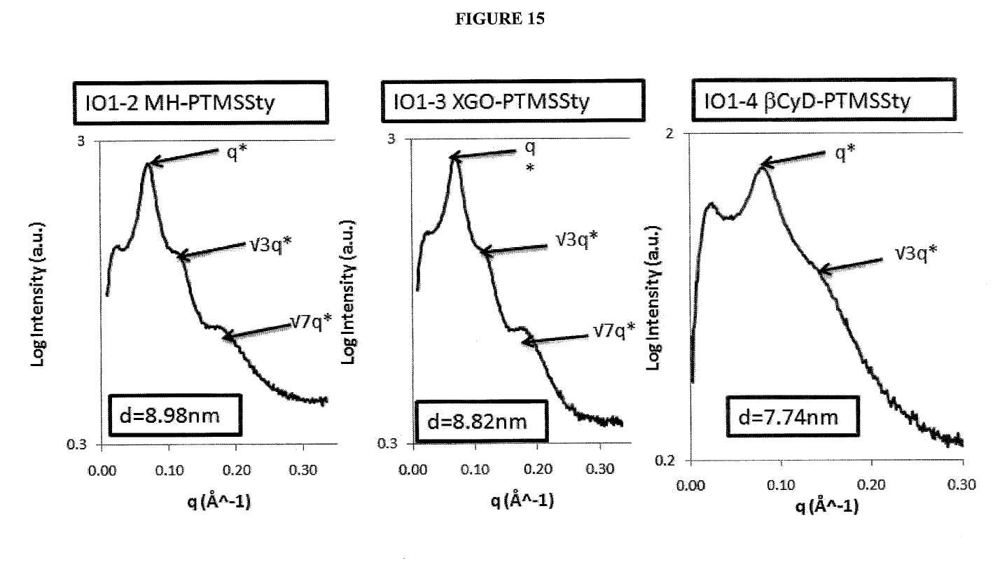

The success of the reactions shown in FIG. 6, FIG. 9, FIG. 10, and FIG. 11 were also confirmed by small angle X-ray scattering. The block copolymer SAXS profiles are shown in FIG. 14. The presence of scattering maxima indicate the presence of a self-assembled block copolymer in all three PTMSiS-b-oligosaccharide bulk systems. We also confirm the presence of patternable nanostructures by atomic force microscopy. FIG. 15 shows nanoscale features present on the surface of the film for a variety of film thicknesses.

### REFERENCES

1. Ross, C. A. (2001) Patterned Magnetic Recording Media, Annu. Rev. Mater. Res. 31, 203-238.
2. Yang, X. et al. (2008) Toward 1 Tdot/in.² nanoimprint lithography for magnetic bit-patterned media: Opportunities and challenges J. Vac. Sci. Technol. 26, 2604-2610
3. Ruiz, R. et al. (2008) Density Multiplication and Improved Lithography by Directed Block Copolymer Assembly, Science 321, 936-939.
4. Bates, F. S, and Fredrickson, G. H. (1990) Block Copolymer Thermodynamics: Theory and Experiment, Annu. Rev. Phys. Chem. 41, 525-557.
5. Li, M. and Ober, C. K. (2006) Block copolymer patterns and templates, Mater. Today 9, 30-39.
6. Colburn, M. et al. (2000) Step and flash imprint lithography for sub-100-nm patterning, Proc. SPIE-Int. Soc. Opt. Eng. 3997, 453-457.
7. Kim, H.-C. et al. (2001) A Route to Nanoscopic SiO₂ Posts via Block Copolymer Templates, Adv. Mater. 13, 795-797.
8. Nagarajan, S. et al. (2008) An Efficient Route to Mesoporous Silica Films with Perpendicular Nanochannels, Adv. Mater. 20, 246-251.
9. Lammertink, R. G. H. et al. (2000) Nanostructured Thin Films of Organic-Organometallic Block Copolymers: One-Step Lithography with Poly(ferrocenylsilanes) by Reactive Ion Etching, Adv. Mater. 12, 98-103.
10. Hillmyer, M. A. and Bates, F. S. (1996) Synthesis and Characterization of Model Polyalkane-Poly(ethylene oxide) Block Copolymers, Macromolecules 29, 6994-7002.
11. Harada, M. et al. (2005) Preparation and phase behavior of poly(4-trimethylsilylstyrene)-block-polyisoprene, Journal of Polymer Science Part B: Polymer Physics 43, 1214-1219.
12. Misichronis, K., Rangou, S., and Avgeropoulos, A. (2008) Synthesis and Molecular and Morphological Characterization of Poly(p-Trimethylsilyl Styrene) and Diblock Copolymers with Poly(1,3-Cyclohexadiene), Int. J. Polym. Anal. Charact. 13, 136-148.
13. Hirai, A. et al. (1982) Polymerization of monomers containing functional groups protected by trialkylsilyl groups, 1. Synthesis of poly(4-vinylphenol) by means of anionic living polymerization, Makromolecular Chemistry, Rapid Communications 3, 941-946.
14. Aissou, K. et al. (2011) Nano-Organization of Amylose-b-Polystyrene Block Copolymer Films Doped with Bipyridine, Langmuir 27, 4098-4103.
15. Giacomelli, C. et al. (2010) Block Copolymer Systems: From Single Chain to Self-Assembled Nanostructures, Langmuir 26, 15734-15744.
16. Sharpless, K. B. (2002) Searching for New Reactivity (Nobel Lecture), “Angew. Chem., Int. Ed.” 41, 2024-2032.
17. Meldal, M. and Tornøe, C. W. (2008) Cu-Catalyzed Azide-Alkyne Cycloaddition, Chemical Reviews 108, 2952-3015.
18. Moses, J. E. and Moorhouse, A. D. (2007) The growing applications of click chemistry, Chem. Soc. Rev. 36, 1249-1262.
19. Bock, V. D., Hiemstra, H., and van Maarseveen, J. H. (2006) CuI-Catalyzed Alkyne-Azide “Click” Cycloadditions from a Mechanistic and Synthetic Perspective, Eur. J. Org. Chem. 2006, 51-68.
20. Uhrig, D. and Mays, J. W. (2005) Experimental techniques in high-vacuum anionic polymerization, J. Polym. Sci. A. 43, 6179-6222.
21. Pangborn, A. B. et al. (1996) Safe and Convenient Procedure for Solvent Purification, Organometallics 15, 1518-1520.

We claim:

1. A method of synthesizing a silicon and oligosaccharide-containing block copolymer, comprising:
a. providing first and second monomers, said first monomer comprising a silicon atom and said second monomer being a oligosaccharide based monomer lacking silicon that can be polymerized;
b. treating said second monomer under conditions such that reactive polymer of said second monomer is formed; and
c. reacting said first monomer with said reactive polymer of said second monomer under conditions such that said silicon-containing block copolymer is synthesized.

2. The method of claim 1, wherein said silicon-containing block is synthesized to contain an azide end-functionality and the oligosaccharide block is designed to contain an alkyne functionality.

3. The method of claim 2, wherein the two blocks are coupled by the azide-alkyne cycloaddition reaction.

4. The product of claim 3, wherein the block copolymers form nanostructured materials that can be used as etch masks in lithographic patterning processes.

5. The product of claim 3, wherein block co-polymer comprised of at least one block of an oligiosaccharide and at least one block of a silicon containing polymer or oligomer with at least 10 wt % silicon.

6. The method of claim 1, wherein one of the blocks is a propargyl-functionalized oligosaccharide.

7. The method of claim 1, wherein one of the blocks is polytrimethylsilylstyrene.

8. The method of claim 1, wherein one of the blocks is end-functionalized with azide.

9. The method of claim 1, wherein said first monomer is trimethyl-(2-methylene-but-3-enyl)silane.

10. The method of claim 1, further comprising d) precipitating said silicon-containing block copolymer in methanol.

11. The method of claim 1, wherein said first monomer is a silicon-containing methacrylate.

12. The method of claim 11, wherein said first monomer is methacryloxymethyltrimethylsilane (MTMSMA).

13. The method of claim 1, wherein said oligosaccaride-containing block copolymer is mal₇-block-P(TMSSty).

14. The method of claim 1, wherein said oligosaccaride-containing block copolymer is mal₇-block-P(MTMSMA).

15. The method of claim 1, wherein said oligosaccaride-containing block copolymer is bCyD-block-PTMSSty.

16. The method of claim 1, wherein said oligosaccaride-containing block copolymer is XGO-block-PTMSSty.

17. The method of claim 1, wherein said second monomer is an oligosaccharide.

18. The method of claim 17, wherein said oligosaccharide is an oligomaltoheptaose.

19. The method of claim 17, wherein said oligosaccharide is an ethynyl-maltoheptaose.

20. The method of claim 17, wherein said oligosaccharide is an ethynyl-maltoheptaose xyloglucooligosaccharide.

21. The method of claim 17, wherein said oligosaccharide is an ethynyl-xyloglucooligosaccharide.

22. The method of claim 17, wherein said oligosaccharide is an ethynyl-βCyD.

23. The method of claim 17, wherein said oligosaccharide is mono-6^{A}-(p-tolylsulfonyl)-β-cyclodextrin.

24. The method of claim 17, wherein said oligosaccharide is mono-6^{A}-N-propargylamino-6^{A}-deoxy-β-cyclodextrin.

25. The method of claim 1, further comprising the step d) coating a surface with said block copolymer so as to create a block copolymer film.

26. The method of claim 25, further comprising the step e) treating said film under conditions such that nanostructures form.

27. The method of claim 26, wherein said nanostructures comprise spherical structures.

28. The method of claim 26, wherein said nanostructures comprise cylindrical structures, said cylindrical structures being substantially vertically aligned with respect to the plane of the surface.

29. The method of claim 26, wherein said treating comprises exposing said coated surface to a saturated atmosphere of acetone or THF.

30. The method of claim 25, wherein said surface is on a silicon wafer.

31. The method of claim 25, wherein said surface is not pre-treated with a cross-linked polymer prior to step d).

32. The method of claim 25, wherein said surface is pre-treated with a cross-linked polymer prior to step d).

33. The method of claim 1, wherein a third monomer is provided and said block copolymer is a triblock copolymer.

34. The film made according to the process of claim 26.

35. A method of forming nanostructures on a surface, comprising:
a. providing a silicon and oligosaccharide-containing block copolymer block copolymer and a surface;
b. spin coating said block copolymer on said surface to create a coated surface; and
c. treating said coated surface under conditions such that nanostructures are formed on said surface.

36. The method of claim 35, wherein said nanostructures comprises cylindrical structures, said cylindrical structures being substantially vertically aligned with respect to the plane of the surface.

37. The method of claim 35, wherein said treating comprises exposing said coated surface to a saturated atmosphere of acetone or THF.

38. The method of claim 35, wherein said surface is on a silicon wafer.

39. The method of claim 35, wherein said surface is not pre-treated with a cross-linked polymer prior to step b).

40. The method of claim 35, wherein said surface is pre-treated with a cross-linked polymer prior to step b).

41. The film made according to the process of claim 35.

42. The method of claim 35, further comprising the step e) etching said nanostructure-containing coated surface.
